(19) United States
(12) Patent Application Publication
(10) Pub. No.: US 2003/0185366 A1
(43) Pub. Date: Oct. 2, 2003

(54) Callee identification feature for telecommunications devices

(75) Inventor: Jennifer Kay Duncan, Fort Worth, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/113,694

(22) Filed: Mar. 29, 2002

(51) Int. Cl. H04M 1/56; H04M 15/06; H04M 3/42

(52) U.S. Cl. 379/142.17; 379/207.14

(57) ABSTRACT

A callee identification feature provides a caller with a visual display of a telephone number that the caller requested from an information service, of a telephone number to which the caller was transferred, and of a new update telephone number if the present telephone number that a caller dialed is no longer accurate. The visual display is provided, for example, when the caller is a subscriber to the callee identification feature. The visual display is provided via a connection from a switched network such as a PSTN (12) when the caller is calling from a landline telephone (16), or on a MSC (18) if the caller is calling from a mobile phone (24).

### FIELD OF THE INVENTION

The present invention relates to telecommunication services, and more particularly to a feature that provides callee identification information to a caller during or after the setup of a telephone call.

### DESCRIPTION OF THE RELATED ART

Conventional caller identification units typically display the number from which an incoming call is placed to enable a called party (callee) to identify a calling party (caller). For example, a feature commonly known as Call Waiting Caller Identification permits a called party of callee to identify a telephone number and typically a name of a calling party or caller while the callee is on another telephone call. However, there is presently no feature that enables a caller or calling party to identify a telephone number, name or other information regarding a called party or callee to which they have been or are being connected.

The need for identifying such a telephone number may arise when a caller is transferred by a callee with or at an originally dialed telephone number to a new telephone number, such as when the caller has dialed an information service to request a telephone number, and is automatically transferred to the requested telephone number by the information service. In these situations, the transfer target number or requested telephone number may be audibly provided to the caller. If the caller needs the information they must manually record the transfer target number or requested telephone number to which they are being or have been transferred. However, callers who are hearing impaired, callers who do not speak or understand English very well, or callers placing calls from locations with a large amount of background noise may not be able to hear or understand the transfer or requested telephone number.

It would therefore be advantageous to provide callee identification to a caller by, for example, forwarding such callee information to the caller via, for example, an existing caller identification unit. It would also be advantageous to store the callee identification in a local memory source for the caller. It would be of greater advantage to provide the feature as a subscription service or for a service fee for revenue generating purposes.

### BRIEF DESCRIPTION OF THE DRAWINGS

Objects and advantages of the present invention will be more readily apparent from the following detailed description of the preferred embodiments thereof when taken together with the accompanying drawings in which:

FIG. 1 is an exemplary view of a system in which a callee identification feature is implemented in accordance with the present invention;

FIG. 2 is a flow diagram of a preferred method embodiment for facilitating callee identification service according to the present invention;

FIG. 3 is a flow diagram of a further method embodiment facilitating callee identification service when a telephone call is transferred from a first callee to a second callee according to the present invention;

FIG. 4 is a flow diagram of a preferred method of providing callee identification service when a caller requests information according to the present invention;

FIG. 5 is an exemplary view of electronic switches suitable for implementing various methods according to the present invention;

FIG. 6 is a flow diagram of another preferred method of providing callee identification service when a caller is given a telephone number for an intended callee by an information service according to the present invention;

FIG. 7 is a flow diagram of a further method of providing callee identification service when a caller is transferred to a second callee by a first callee according to the present invention; and

FIG. 8 is an exemplary view of electronic switches suitable for implementing the FIG. 7 method.

### DETAILED DESCRIPTION OF THE PREFERRED EMBODIMENTS

The instant disclosure is provided to further explain in an enabling fashion the best modes of performing the embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of specific software instructions will be limited in the interest of brevity and minimization of any risk of obscuring the principles and concepts in accordance with the present invention.

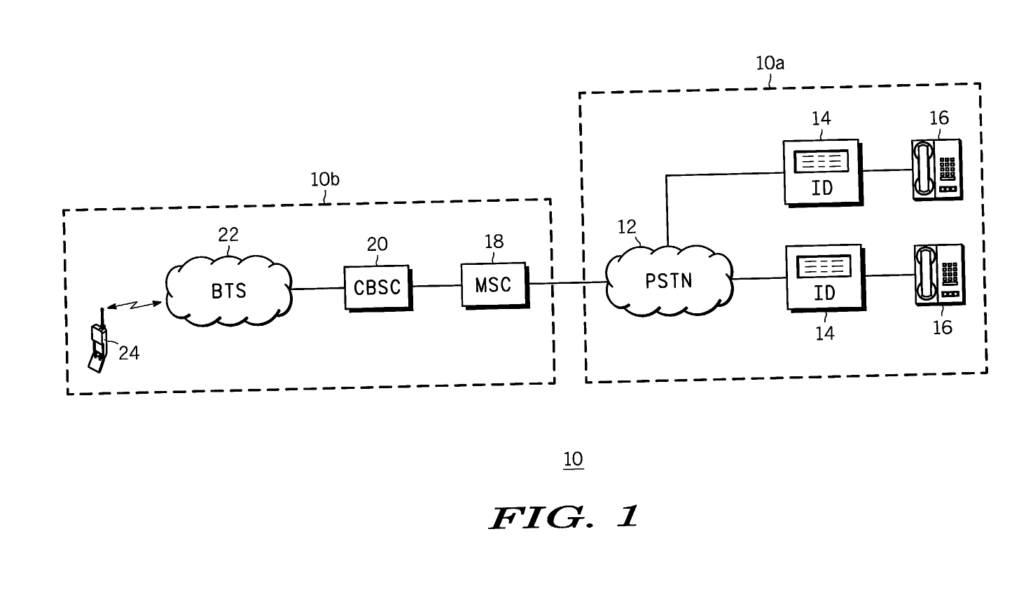

Referring now to the drawings in which like numerals reference like parts, FIG. 1 shows an exemplary system (system) 10, which includes a land based section 10a and a wireless section 10b, in which various methodologies for implementing the callee identification feature of the present invention may be implemented.

The land based section 10a includes a public switched telephone network (PSTN) 12, a plurality of caller identification units 14 and landline telephones 16. As understood by those skilled in the art, the PSTN 12 provides a switching connection with landline telephones that are represented for purposes of illustration and discussion by exemplary landline telephones 16. The caller identification unit 14 provides the user of the landline telephone 16 with a means for receiving and displaying caller ID information such as the telephone number and perhaps a name associated with an incoming telephone call. The caller identification unit 14 may optionally be included with the telephone rather than being a separate device.

The wireless section 10b includes a mobile switching center (MSC) 18, a centralized base station controller (CBSC) 20, a base transceiver station (BTS) 22 and mobile subscriber units that are represented generally for purposes of illustration and discussion by a mobile telephone 24, that includes built in caller identification capability. As understood by those skilled in the art, the MSC 18 provides a switching connection with the mobile telephone 24. This switching connection can be further established between the landline telephone 16 and the mobile phone 24 via the PSTN 12 and the MSC 18.

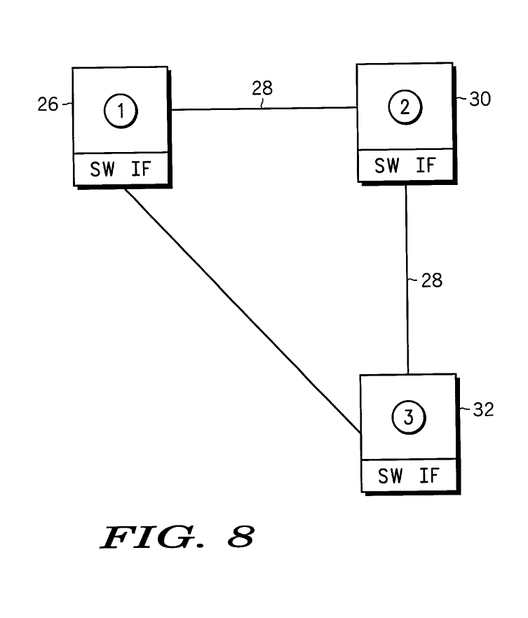

As understood by those skilled in the art, the PSTN 12 and the MSC 18 each include one or more electronic switches. (See, e.g., 26, 28, 30 of FIG. 5 and FIG. 8). Each electronic switch includes an interface, typically software interface, that provides supplementary services in conjunction with regular switched telephone service preferably for a monthly subscription fee. Examples of such supplementary features include call waiting, caller identification and *69 callback features. The software interface commands the respective electronic switch at the PSTN 12 or the MSC 18 to implement the supplementary features based on a subscriber profile or services list or profile that is stored at or within the switching network. In accordance with the present invention, a callee identification service can also be provided as a supplementary feature by modifying the software interface in accordance with the principles and concepts discussed and disclosed herein in a manner so as to advantageously utilize currently available caller identification technology.

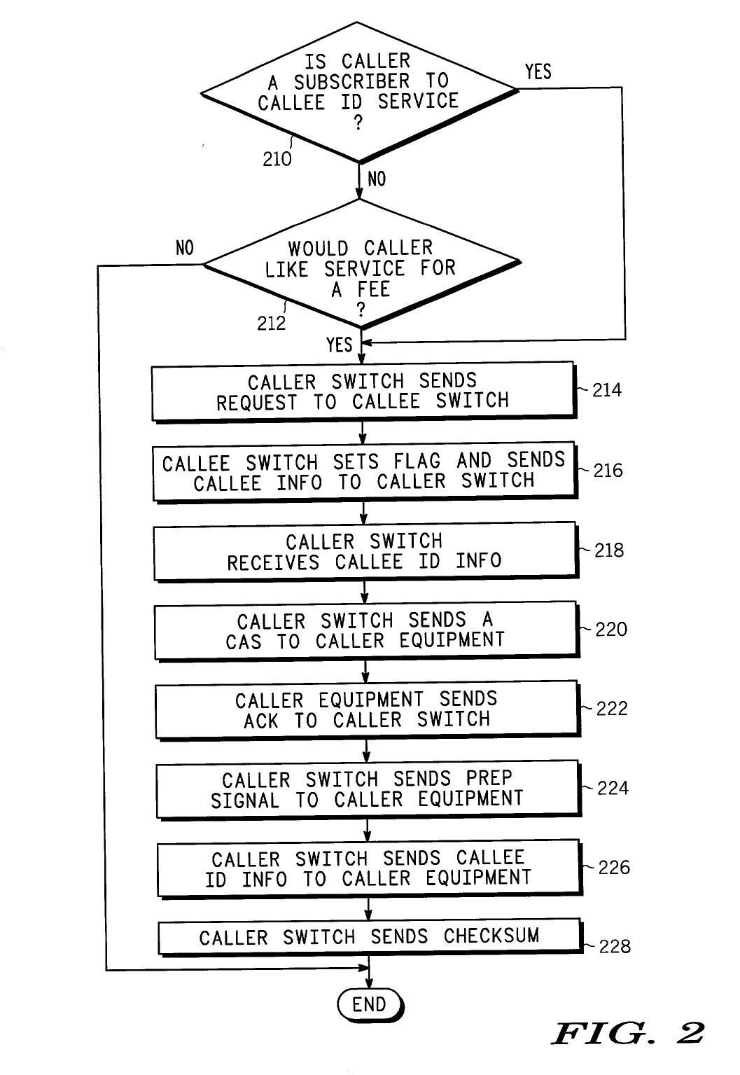

Operation of the electronic switches in conjunction with the modified software interface (the “callee identification process”) will be more fully discussed in connection with the flow diagram of the method of FIG. 2 and the exemplary view of a connection between two electronic switches of FIG. 5. The callee identification process begins after a connection has been established or during the establishment of a connection between a caller and a callee. More specifically, referring to FIG. 5, a switch to which a caller is connected (caller switch) 26 establishes a connection with a switch to which a callee is connected (callee switch) 30 via a trunk 28. In actual service, the connection may be established via numerous switches and trunks. It is also possible that the caller and callee switch are the same switch. However, only two switches are shown for purposes of illustration. Referring to FIG. 2, at 210, the caller switch 26 determines if the caller is a subscriber to the callee identification feature. Specifically, the caller switch 26 determines, for example, whether the caller currently has agreed to pay a fee for the callee identification feature to his or her telephone service provider. If the caller is not a subscriber, the callee identification process proceeds to 212 where the caller switch determines if the caller has indicated an intent to use the feature for a service fee. The caller could indicate an intent to pay the service fee necessary to enable the callee identification feature by, for example, dialing a sequence of digits on his or her telephone or by audibly indicating an intent to pay for the callee identification feature via his or her telephone headset in response to a prompt. If it is determined that the caller is not a subscriber to the caller identification feature at 210, and that the caller has not indicated an intent to pay the callee identification feature service fee at 212, the callee identification process ends.

If it is determined that the caller is a subscriber to the callee identification feature at 210, or that the caller has indicated an intent to pay for the callee identification feature at 212, the callee identification process proceeds to 214. At 214, the caller switch 26 sends a request for callee identification information to the callee switch 30. At 216, the callee switch 30 records the request by setting a flag and sends the callee identification information to the caller switch 26 via the trunk 28. At 218, the caller switch 26 receives the callee identification information. At 220, the caller switch 26 sends a customer alerting signal (CAS) to the customer premise equipment (CPE) or caller's handset or caller equipment, such as one of the telephones 16 or the mobile telephone 24. The CAS warns the CPE that the caller switch 26 has information to send. At 222, the CPE or caller equipment mutes its handset and sends an acknowledgement signal (ACK) to the caller switch 26 in response to the CAS. At 224, the caller switch 26 receives the ACK from the CPE and sends a prep signal to the CPE instructing the CPE to prepare its data receiver for the reception of the callee identification information. The data receiver could be, for example, the caller identification unit 14 connected to the landline telephone 16 or the built in caller identification capabilities of mobile telephone 24. At 226, the caller switch 26 sends the callee identification information to the CPE. The callee identification information is transmitted through a signaling system and is displayed in ASCII character form on the data receiver of the CPE. Examples of such signaling systems include Multi-Frequency and Signaling System Number 7. The callee identification information could be transmitted in multiple data message format (MDMF), which is the format used for Call Waiting Caller Identification, and for callee identification information preferrably includes the date, time, callee or called number and name associated with the callee or called number. Finally, at 228 the caller switch 26 sends a checksum to the caller CPE to facilitate a check for errors by the caller equipment or CPE. The process by which the caller switch 26 forwards the callee identification information to the caller CPE (220-228 of the callee identification process 200) is referred to as the “core process”.

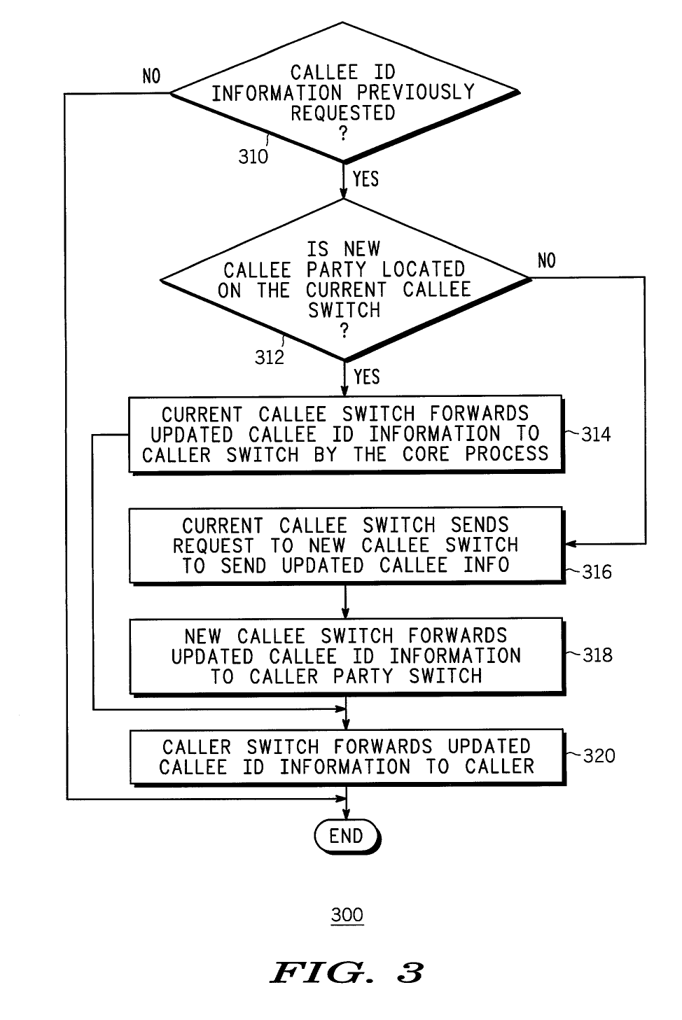

Operation of the electronic switches in conjunction with their respective software interface, modified according to the principles and concepts discussed and disclosed herein, during a transfer telephone call (the “transfer process”) will be more fully discussed in connection with the flow diagram shown generally at 300 with reference to the flow diagram of the method of FIG. 3 and the exemplary view of a connection between electronic switches of FIG. 8.

The transfer process 300 begins after a connection has been established between a caller and a first (current) callee and during or while the current callee switch 30 transfers the connection to a new callee switch 32. At 310, the current callee switch 30 determines if callee identification information was previously requested by checking the flag status from step 216. If the flag was not set implying that the caller is not interested in callee identification services, the transfer process ends. If the flag was set, the transfer process proceeds to 312.

At 312, the current callee switch 30 determines if the new callee party is located on the current callee switch 30. The transfer process 300 proceeds to 314 if the new callee party is located on the current callee switch 30. At 314 the current callee switch 30 forwards updated callee identification information to the caller switch 26, which forwards the callee identification information to the caller or caller CPE at 320 by the core process.

If the new party or new callee or callee that the callers call is being transferred to is not located on the current callee switch 30, the transfer process proceeds to 316. At 316, the current callee switch 30 sends via the trunk 28 between switches 30 and 32, a request to the new callee switch 32 to send the updated callee identification information. At 318 the new callee switch 32 forwards the updated callee identification information to the caller switch 26 via the connection between switches 26, 32 depicted. At 320, the caller switch forwards the updated callee identification information to the caller CPE by the core process. The transfer process could optionally be performed before or after the current callee switch 30 transfers the connection to the new callee switch 32. Also note that multiple transfers can occur with essentially the method 300 being repeated for each transfer.

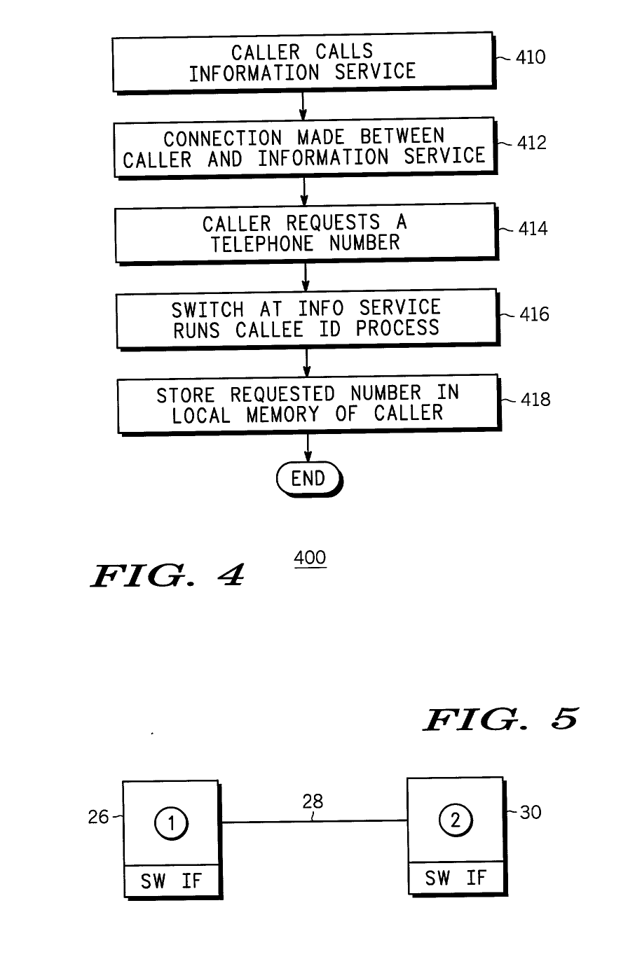

Referring now to FIG. 4 and FIG. 5, a further method 400 for implementing the callee identification feature according to the present invention will be discussed. This method is applicable to a situation in which a caller calls an information service, such as, for example “411”, and requests a telephone number. At 410, the caller calls the information service. At 412, a link or connection is established between the caller (via caller switch 26) and the information service (via callee switch 30). The caller switch 26 could be on the PSTN 12 if the caller is calling from, for example, the landline telephone 16 or via the MSC 18 if the caller is calling from, for example, the mobile telephone 24. The callee switch 30 may be on a different switched network than the caller switch 26. At 414, the caller requests a telephone number from the information service that the caller is linked to.

At 416, the software interface of the callee switch 30 at the information service executes the callee identification process of FIG. 2 with the exception of the flag setting operation of steps 214 and 216. As a result, the requested telephone number is displayed on the caller's data receiver, such as caller identification unit 14. Subsequently, at 418, the requested telephone number is stored in a local memory source of the caller. For example, if the caller is calling from the mobile telephone 24, and the mobile telephone 24 includes an electronic address directory (telephone log), the requested or callee telephone number may be automatically stored in the telephone log.

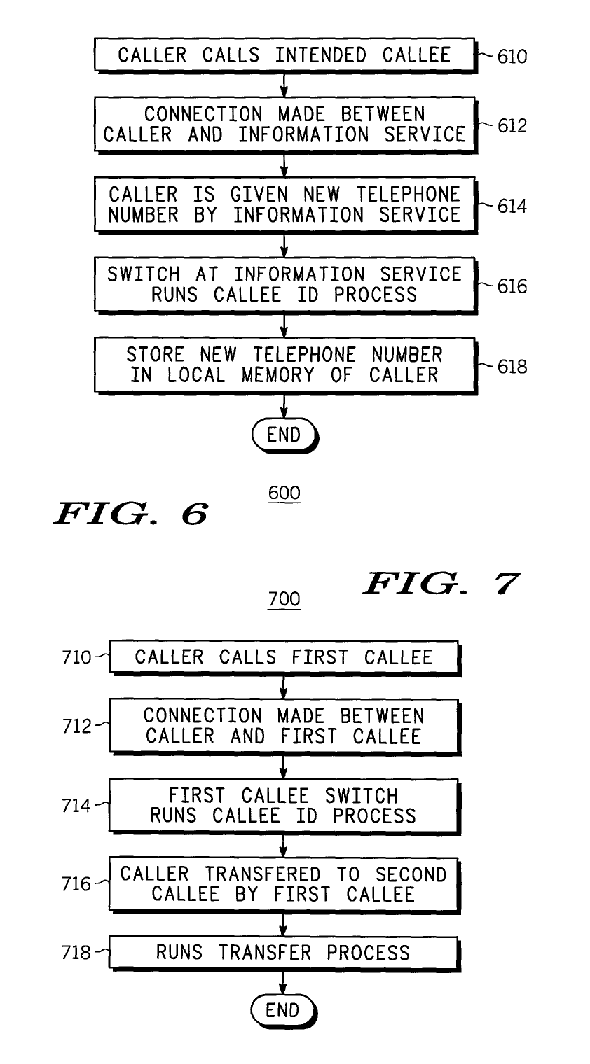

Referring now to FIG. 5 and FIG. 6, a further method 600 of providing callee identification information will be discussed. This embodiment is applicable to a situation where a caller calls a first party (intended callee) and is connected by an information service to an automatic advisory message that audibly informs the caller that the telephone number of the intended callee has changed to a new telephone number.

At 610, the caller calls the intended callee. At 612, a connection is established between the caller (via caller switch 26) and an information service (via callee switch 30) rather than the intended callee because the telephone number of the intended callee has changed. The caller switch 26 could be on the PSTN 12 if the caller is calling from, for example, the landline telephone 16 or via the MSC 18 if the caller is calling from, for example, the mobile telephone 24. The callee switch 30 may be on the same or a different switching network than the caller switch 26. At 614 the information service audibly informs the caller that the telephone number of the intended callee has changed to a new telephone number.

At 616, the software interface of the callee switch 30 executes the callee identification process 200. As a result, the new telephone number, preferably name and other information is displayed on the caller's data receiver. At 618, the new telephone number is stored in the telephone log of the caller. The new telephone number of the intended party may optionally replace the original telephone number in the telephone log of the intended party.

Referring now to FIG. 7 and FIG. 8, another method 700 for providing caller identification will be discussed. This embodiment applies to a situation in which a caller (on caller switch 26) calls a first callee and, after establishing a connection with the first callee (via first callee switch 30), is transferred by the first callee to a second callee (on second callee switch 32). At 710, the caller calls the first callee. At 712, a connection is established between the caller and the first callee. The caller switch 26 could be on the PSTN 12 if the caller is calling from, for example, the landline telephone 16 or via the MSC 18 if the caller is calling from, for example, the mobile telephone 24. The callee switch 30 could be on a different switching network than the caller switch 26. At 714, the first callee switch 30 executes the callee identification process 200. At 716, the caller is transferred to a second callee by the first callee. At 718, the transfer process 300 described above in connection with FIG. 3 is executed. As a result, the telephone number of the second callee is displayed on the caller's data receiver. The above process could happen repeatedly if the caller is transferred multiple times.

Therefore, the present invention provides a callee identification feature that identifies the telephone number, name and so forth of the party to which the calling party has been connected (callee identification information) by modifying the software interface of an electronic switch in accordance with the principles and concepts disclosed herein. Thus utilizing currently available caller identification technology to receive and display the callee identification information is advantageously exploited. The callee identification feature is preferably provided in conjunction with other supplementary features.

While the above description concerns various of the preferred embodiments of the present invention, it should be appreciated that the invention may be modified, altered, or varied without deviating from the scope and fair meaning of the following claims. For example, the methodology of the first embodiment could be combined with the third embodiment so that a caller could receive the callee identification information when the information service automatically transfers the caller to the requested telephone number.

What is claimed is:

1. A method for providing a callee identification feature comprising:
receiving identification information of a callee party via a connection established between the callee party and a caller party on a switched network; and
displaying the telephone identification information to the caller party.

2. The method of claim 1, further comprising storing the identification information in a local memory source of the caller party.

3. The method of claim 1, wherein the receiving identification information of a callee party via a connection established between the callee party and the caller party on a switched network further comprises receiving updated identification information corresponding to the callee party.

4. The method of claim 3 further comprising displaying the updated identification information of the callee party to the caller party.

5. The method of claim 1, wherein the receiving identification information of a callee party via a connection established between the callee party and the caller party on a switched network further comprises receiving new identification information when the caller party is transferred from the callee party to a new callee party.

6. The method of claim 5, wherein the displaying the identification information to the caller party further comprises displaying the new identification information when the caller party is transferred from the callee party to the new callee party.

7. The method of claim 6, further comprising storing the identification information and the new identification information in a local memory source.

8. A method for providing callee identification comprising:
establishing a link between a callee party and a caller party on a switching network;
determining if the caller party has a subscription to a callee identification service;
receiving callee identification information via the link between the callee party and the caller party; and
forwarding the callee identification information to the caller party in a display suitable format.

9. The method of claim 8, wherein:
the receiving callee identification information via the link from the callee party and the caller party further comprises receiving updated callee identification information corresponding to the callee party when a request for the update callee identification information is made by the caller party; and
the forwarding the callee identification information to the caller party in a display suitable format further comprises forwarding the updated callee identification information to the caller party in the display suitable format.

10. The method of claim 8, wherein:
the receiving callee identification information via the link between the callee party and the caller party further comprises receiving updated callee identification information when the caller party is transferred from the callee party to a new callee party; and
the forwarding the callee identification information to the caller party in a display suitable format further comprises forwarding the updated callee identification information to the caller party in a display suitable format.

11. The method of claim 8, further comprising modifying a software interface at an electronic switch of a switching network so as to perform the determining if the caller party has the subscription to the callee identification service, the receiving the callee identification information via the link between the callee party and the caller party, and the forwarding the callee identification information to the caller party in the display suitable format.

12. The method of claim 8, further comprising permitting the caller party to receive the callee identification information if the caller party has a subscription to a callee identification service.

13. The method of claim 8, further comprising:
receiving new callee identification information from the callee party when one of the caller party requests new callee identification information from the callee party and the caller party is transferred from the callee party to a new callee party;
the forwarding the callee identification information to the caller party in a display suitable format further comprises forwarding the new callee identification information to the caller party in a display suitable format;
determining if the caller party has indicated an intent to pay a service fee if the determining if the caller party has a subscription to a callee identification service determines that the caller party does not have the subscription to the callee identification service;
permitting the caller party to receive the callee identification information if the determining if the caller party has indicated an intent to pay a service fee determines that the caller party has indicated the intent to pay the service fee; and
modifying a software interface at an electronic switch of a switching network so as to perform the determining if the caller party has the subscription to a callee identification service, the receiving the callee identification information via the link connection between the callee party and the caller party and the forwarding the callee identification information to the caller party in the display suitable format.

14. The method of claim 8, further comprising sending callee identification information to a caller party via the link between the callee party and the caller party.

15. The method of claim 14, further comprising requesting update callee identification information from a new callee party switch when a caller party is being transferred from a current callee party switch to the new callee party switch.

16. The method of claim 15, further comprising forwarding the updated callee identification information from the new callee party switch to the caller party switch.

17. The method of claim 8, further comprising sending a request for callee identification information to a callee switch.

18. The method of claim 17, further comprising forwarding the callee identification information to the caller switch and recording the request for callee identification information.

19. The method of claim 16, further comprising determining if the caller has a subscription to a callee identification service before the sending of updated callee identification information from the callee party to the caller party via the link upon a demand by the caller.

20. A system for providing a callee identification feature comprising:
a first telephone receiver with means for receiving and displaying digital caller identification information and means for initiating a connection via a switching network with a second telephone receiver;
means for sending digital telephone identification information corresponding to the second telephone receiver to the first telephone receiver via the switching network;
means for determining if a telephone line to which the first telephone receiver is connected has a subscription to the callee identification feature; and
means for determining if an intent to pay a service fee has been indicated on the telephone line to which the first telephone receiver is connected,
wherein the means for sending digital telephone identification information of the second telephone receiver to the first telephone receiver via the switching network only sends the digital telephone identification information if the means for determining if a telephone line to which the first telephone receiver is connected has a subscription to the callee identification feature determines that the telephone line has the subscription or if the means for determining if an intent to pay a service fee has been indicated on the telephone line to which the first telephone receiver is connected determines that the intent has been indicated.

21. The system of claim 20, wherein the means for sending digital telephone identification information corresponding to the second telephone receiver to the first telephone receiver via the switching network, the means for determining if a telephone line to which the first telephone receiver is connected has a subscription to 5 the callee identification feature and the means for determining if an intent to pay a service fee has been indicated on the telephone line to which the first telephone receiver is connected comprises a callee identification process of a software interface on an electronic switch at a switching network.

22. The system of claim 21, wherein the means for receiving and displaying digital caller identification information comprises a caller identification unit.
